(19) United States
(12) Patent Application Publication
(10) Pub. No.: US 2016/0179413 A1
(43) Pub. Date: Jun. 23, 2016

(54) HYBRID MEMORY HAVING ONE-BIT SYNCHRONIZATION FUNCTION AND BOOTING METHOD AND BOOTING SYSTEM USING THE SAME

(71) Applicant: TINNOS INC., Seoul (KR)

(72) Inventor: Dong Yup LEE, Bucheon-si (KR)

(21) Appl. No.: 14/602,106

(22) Filed: Jan. 21, 2015

(30) Foreign Application Priority Data
Dec. 19, 2014 (KR) 10-2014-0184591
Jan. 7, 2015 (JP) 2015-001387

(51) Int. Cl. G06F 3/06

(52) U.S. Cl. CPC G06F 3/0619; G06F 3/0679; G06F 3/068; G06F 3/065

(57) ABSTRACT

A hybrid memory includes a cell memory unit including a plurality of hybrid cells each including a DRAM (Dynamic Random Access Memory) area and a flash memory area and each having a one-bit synchronization function of copying bit information between the DRAM area and the flash memory area and a cell controller that copies information stored in the flash memory area to the DRAM area and copies information stored in the DRAM area to the flash memory area. The cell controller copies the information from the flash memory area to the DRAM area in a one-bit synchronization basis in which the bit information is copied in the plurality of hybrid cells in a simultaneous manner and copies the information from the DRAM area to the flash memory area in the one-bit synchronization basis.

### CROSS-REFERENCE TO RELATED APPLICATIONS

This application claims the benefit of Korean Patent Application No. 10-2014-0184591 filed with the Korean Intellectual Property Office on Dec. 19, 2014 and Japanese Patent Application No. 2015-001387 filed with the Japan Patent Office on Jan. 7, 2015, the disclosures of which are incorporated herein by reference.

### BACKGROUND

1. Field

The present disclosure relates to a hybrid memory having a one-bit synchronization function and a booting method and a booting system using the hybrid memory, and more particularly, to a hybrid memory including a flash memory area and a DRAM (Dynamic Random Access Memory) memory area and having a one-bit synchronization function of copying information in a one-bit synchronization basis between the flash memory area and the DRAM area and a booting method and a booting system for speeding up a booting process by using the hybrid memory.

2. Description of the Related Art

In a computer system, in general, a CPU (Central Processing Unit) performs a booting operation of the system by copying firmware stored in a flash memory to a DRAM and then reading the firmware from the DRAM. Therefore, in such a computer system, the booting process is performed after the CPU reads the firmware stored in the flash memory and copies the firmware to the DRAM.

For this reason, until the booting process is completed, a predetermined time is required for the CPU to access firmware information stored in the flash memory, to read the firmware information, and to copy the firmware information to the DRAM. Therefore, in order to reduce the time for the booting process, the time for accessing the flash memory, reading the firmware information, and copying the firmware information to the DRAM needs to be shortened.

Korean Patent Application Laid-Open No. 10-2014-0091818 describes a kernel hibernation method, which is a snapshot booting method provided by Linux™ kernel.

According to the kernel hibernation method, at the time of shutting down the system, pieces of status information of a RAM, a CPU, and a device at that time are stored in a disk or a flash memory. At the time of the next booting, after a general initialization process, the pieces of status information stored in the disk or the flash memory are loaded to the flash memory to recover the last status of the system, thus speeding up the booting process. However, even in this kernel hibernation method, the CPU needs to intervene to access the disk and the flash memory.

### SUMMARY

A hybrid memory according to some embodiments includes a cell memory unit including a plurality of hybrid cells each including a DRAM (Dynamic Random Access Memory) area and a flash memory area and each having a one-bit synchronization function of copying bit information between the DRAM area and the flash memory area and a cell controller configured to copy information stored in the flash memory area to the DRAM area and to copy information stored in the DRAM area to the flash memory area. The cell controller is configured to copy the information from the flash memory area to the DRAM area in a one-bit synchronization basis in which the bit information is copied in the plurality of hybrid cells in a simultaneous manner and to copy the information from the DRAM area to the flash memory area in the one-bit synchronization basis.

A booting system according to some embodiments includes a hybrid memory including a plurality of hybrid cells each including a DRAM (Dynamic Random Access Memory) area and a flash memory area and each having a one-bit synchronization function of copying bit information between the DRAM area and the flash memory area, a power detection unit configured to detect a power activation, a hybrid memory control unit configured, upon the power detection unit detecting the power activation, to copy firmware stored in the flash memory area to the DRAM area in a one-bit synchronization basis in which the firmware is copied in the plurality of hybrid cells in a simultaneous manner, and a system control unit configured to access the DRAM area, to read the firmware from the DRAM area, and to perform a booting process based on the firmware read from the DRAM area.

A booting method according to some embodiments includes detecting a power activation, upon detecting the power activation, copying firmware stored in a flash memory area to a DRAM (Dynamic Random Access Memory) area of a hybrid memory that includes a plurality of hybrid cells each including the DRAM area and the flash memory area and each having a one-bit synchronization function of copying bit information between the DRAM area and the flash memory area, in a one-bit synchronization basis in which the firmware is copied in the plurality of hybrid cells in a simultaneous manner, and upon completing a copy of the firmware from the flash memory area to the DRAM area, accessing the DRAM area, reading the firmware from the DRAM area, and performing a booting process based on the firmware read from the DRAM area.

The above and other objects, features, advantages and technical and industrial significance of this disclosure will be better understood by reading the following detailed description of exemplary embodiments of the disclosure, when considered in connection with the accompanying drawings.

### BRIEF DESCRIPTION OF THE DRAWINGS

FIG. 1 is a schematic diagram of a system including a hybrid memory according to some embodiments;

FIG. 2 is a schematic diagram of the hybrid memory according to some embodiments;

FIG. 3 is a schematic diagram of a hybrid cell according to some embodiments;

FIG. 4 is flowchart of a booting method in a one-bit synchronization basis according to some embodiments; and

FIG. 5 is a flowchart of a firmware updating method in a one-bit synchronization basis according to some embodiments.

### DETAILED DESCRIPTION OF THE PREFERRED EMBODIMENTS

Exemplary embodiments of the present disclosure are described in detail below with reference to the accompanying drawings.

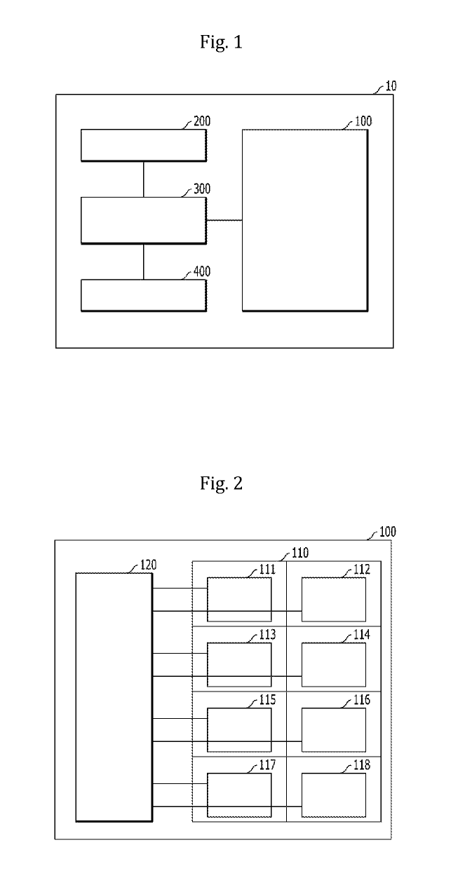

FIG. 1 is a schematic diagram of a system 10 for speeding up a booting process by using a hybrid memory according to some embodiments.

The system 10 according to some embodiments, which speeds up the booting process in a one-bit synchronization basis, includes a hybrid memory 100, a power detection unit 200, a hybrid memory control unit 300, and a system control unit 400.

The hybrid memory 100 includes a cell memory unit 110 including a plurality of hybrid cells 111 to 118 each including a DRAM area and a flash memory area and a cell controller 120 that controls bit information of each of the plurality of hybrid cells 111 to 118. In general, software for controlling a computer system (hardware), which is referred to as firmware, is stored in the flash memory area.

When the power is activated in the system 10, the power detection unit 200 detects the power activation.

Upon the power detection unit 200 detecting the power activation, the hybrid memory control unit 300 copies the firmware from the flash memory area to the DRAM area. At this time, the hybrid memory 100 according to some embodiments has a one-bit synchronization function between the flash memory area and the DRAM area, and copies information from the flash memory area or vice versa in the plurality of hybrid cells 111 to 118 in a simultaneous manner.

That is, the hybrid-memory control unit 300 performs a control of promptly copying the firmware from the flash memory area to the DRAM area without intervention of the CPU at the time when the power is activated.

When the firmware is copied from the flash memory area to the DRAM area, the system control unit 400 accesses the DRAM area, and performs a booting process by executing the firmware. When the booting process is completed, the system control unit 400 executes various application programs running on the system.

That is, the system control unit 400 includes the CPU, and controls an operation of the system after the booting of the system is completed.

The system 10 according to some embodiments considerably speeds up the booting process by promptly copying the firmware from the flash memory area to the DRAM area without intervention of the CPU, compared to the typical system that performs the booting process after the CPU reading the firmware from the flash memory and copying the read information to the DRAM.

Further, when updating the firmware, the system 10 according to some embodiments copies firmware update information stored in the DRAM area to the flash memory area, and hence the firmware can be updated in a rapid and easy manner, compared to a typical system that requires a long time to update the firmware in the flash memory.

FIG. 2 is a schematic diagram of the hybrid memory 100 according to some embodiments.

The hybrid memory 100 according to some embodiments includes the cell memory unit 110 and the cell controller 120.

The cell memory unit 110 includes the plurality of hybrid cells 111 to 118. Each of the plurality of hybrid cells 111 to 118 includes the flash memory area and the DRAM area in a single cell.

In some embodiments, as shown in FIG. 2, the cell memory unit 110 includes eight hybrid cells 111 to 118; however, the number of hybrid cells included in a single cell is not limited to a specific number, but can take arbitrary number as appropriate.

In some embodiments, each of the plurality of hybrid cells 111 to 118 is capable of storing one-bit information.

The cell controller 120 controls the bit information of each of the plurality of hybrid cells 111 to 118.

That is, the cell controller 120 controls a copy of the bit information between a flash memory circuit and a DRAM circuit includes in each of the plurality of hybrid cells 111 to 118.

An operation of the cell controller 120 is described in detail below.

When the power is activated, the cell controller 120 is controlled by the hybrid memory control unit 300 to copy the bit information from the flash memory circuit of the flash memory area to the DRAM circuit of the DRAM area included in each of the plurality of hybrid cells 111 to 118.

That is, the cell controller 120 controls the bit information stored in the flash memory circuits of the plurality of hybrid cells 111 to 118 to be copied to the corresponding DRAM circuits in a simultaneous manner (one-bit synchronization).

In the same manner, the cell controller 120 also controls the bit information stored in the DRAM circuits of the plurality of hybrid cells 111 to 118 to be copied to the corresponding flash memory circuits in a simultaneous manner (one-bit synchronization).

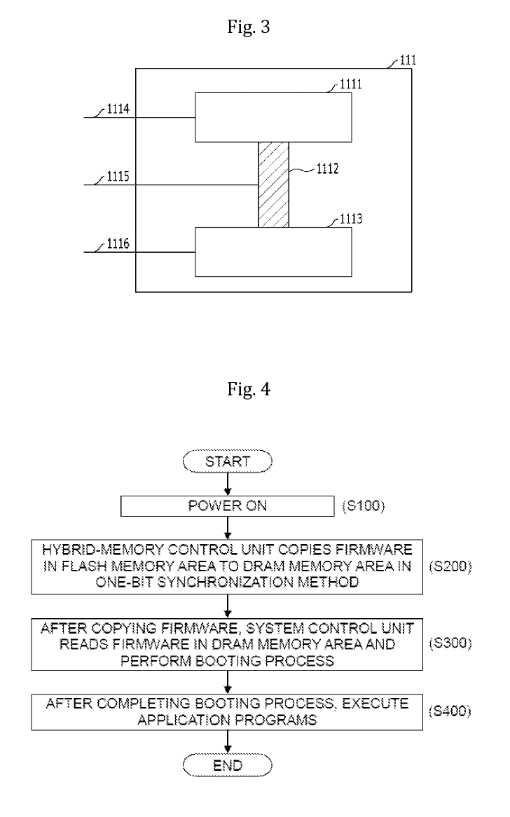

A structure of each of the plurality of hybrid cells 111 to 118 is described in detail below with reference to FIG. 3.

FIG. 3 is a schematic diagram of the hybrid cell 111 according to some embodiments.

As described above, the cell memory unit 110 according to some embodiments includes a plurality of hybrid cells. Although the hybrid cell 111 is described below as an example for the sake of explanation, the other hybrid cells 112 to 118 have the same structure and the same function as the hybrid cell 111.

The hybrid cell 111 includes a DRAM area 1111 including a DRAM circuit, a flash memory area 1113 including a flash memory circuit, and a bit transfer unit 1112 that electrically connects the DRAM area 1111 and the flash memory area 1113.

The DRAM area 1111 includes the DRAM circuit that can store one-bit information.

The flash memory area 1113 includes the flash memory circuit that can store one-bit information.

The DRAM area 1111, the bit transfer unit 1112, and the flash memory area 1113 operate under a control of the cell controller 120, such that the bit information stored in the flash memory area 1113 can be copied to the DRAM area 1111, and in the same manner, the bit information stored in the DRAM area 1111 can be copied to the flash memory area 1113.

To this end, the DRAM area 1111, the bit transfer unit 1112, and the flash memory area 1113 are connected to the cell controller 120 with control lines 1114, 1115, and 1116, respectively.

Although a single control line 1114 of the DRAM area 1111 is shown in the drawing, the control line 1114 includes a REFRESH line for refreshing the DRAM area 1111, a READ line for reading bit information stored in the DRAM area 1111, and a WRITE line for writing bit information in the DRAM area 1111.

Although a single control line 1116 of the flash memory area 1113 is shown in the drawing, the control line 1116 includes a READ line for reading bit information stored in the flash memory area 1113 and a WRITE line for writing bit information in the flash memory area 1113.

A control of the cell controller 120 to copy the bit information from the flash memory area 1113 to the DRAM area 1111 is described below.

The cell controller 120 controls the bit transfer unit 1112 to electrically connect the DRAM area 1111 and the flash memory area 1113. The cell controller 120 then reads the bit information through the READ line of the flash memory area 1113 and writes the bit information read from the flash memory area 1113 in the DRAM area 1111 through the WRITE line of the DRAM area 1111.

To this end, in some embodiments, the bit transfer unit 1112 includes an FET circuit (switch) structure. In this case, the cell controller 120 can copy the bit information by controlling a gate voltage of the FET circuit to open a drain-source channel.

In the same manner, the cell controller 120 reads the bit information through the READ line of the DRAM area 1111, and writes the bit information read from the DRAM area 1111 in the flash memory area 1113 through the WRITE line of the flash memory area 1113.

Alternatively, the bit transfer unit 1112 can electrically connect the DRAM area 1111 and the flash memory area 1113 in a direct manner without having the switch structure. In this case, for example, the cell controller 120 can write the bit information outputted from the flash memory area 1113 in the DRAM area 1111 by setting the WRITE line of the DRAM area 1111 active at the timing of copying the bit information.

FIG. 4 is flowchart of a booting method in a one-bit synchronization basis according to some embodiments.

At Step S100, the power of the system 10 is activated. When the power is activated, the power detection unit 200 detects the power activation, and outputs a signal indicating the power activation to the hybrid memory control unit 300.

At Step S200, the hybrid memory control unit 300 copies the firmware from the flash memory area 1113 to the DRAM area 1111 in the one-bit synchronization basis.

As described above, the cell memory unit 110 of the hybrid memory 100 includes the plurality of hybrid cells 111 to 118. Each of the plurality of hybrid cells 111 to 118 can store one-bit information. Each of the plurality of hybrid cells 111 to 118 includes the DRAM area 1111 and the flash memory area 1113. The firmware is stored in the flash memory area 1113 of each of the plurality of hybrid cells 111 to 118, and copied to the DRAM area 1111 under a control of the cell controller 120. At this time, a copy of the bit information from the flash memory area 1113 to the DRAM area 1111 is performed in all of the plurality of hybrid cells 111 to 118 in a simultaneous manner (one-bit synchronization).

Therefore, in some embodiments, a time for copying the firmware from the flash memory area 1113 to the DRAM area 1111 is substantially equal to a time for copying one-bit information. That is, by using the one-bit synchronization, the firmware can be copied from the flash memory to the DRAM in the time for copying one-bit information.

After the firmware is copied to the DRAM area 1111, at Step S300, the system control unit 400 reads the firmware from the DRAM area 1111, and performs the booting process.

When the booting process is completed, at Step S400, the system control unit 400 executes various application programs to be used in the system.

In some embodiments, as the time for copying the firmware from the flash memory to the DRAM in the system booting process is substantially equal to the time for copying one-bit information, the booting process can be considerably speeded up, compared to the typical booting process.

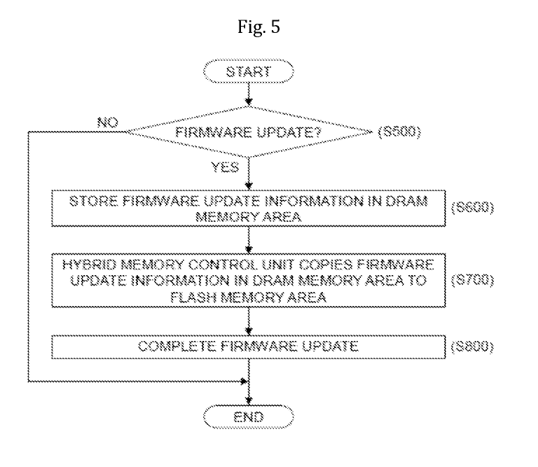

FIG. 5 is a flowchart of a firmware updating method in a one-bit synchronization basis according to some embodiments.

At Step S500, it is determined whether the firmware needs to be updated.

When the determination at Step S500 indicates that there is no need for updating the firmware (NO at Step S500), the process ends without executing the firmware update process.

When the determination at Step S500 indicates that the firmware needs to be updated (YES at Step S500), at Step S600, necessary firmware update information is downloaded and stored in the DRAM area 1111 of the plurality of hybrid cells 111 to 118.

At Step S700, in order to apply the firmware update information to the flash memory, the hybrid memory control unit 300 copies the hybrid memory control unit 300 from the DRAM area 1111 of the plurality of hybrid cells 111 to 118 to the flash memory area 1113 in the one-bit synchronization basis.

As described above, the cell for storing the one-bit information in the hybrid memory 100 according to some embodiments has a hybrid cell structure, and each of the plurality of hybrid cells 111 to 118 includes the DRAM area 1111 and the flash memory area 1113, and hence simply by copying the firmware update information from the DRAM area 1111 to the flash memory area 1113 in the one-bit synchronization basis, the firmware can be updated.

Therefore, the method of updating the firmware according to some embodiments enables the firmware to be updated in a rapid and easy manner, compared to the typical firmware updating method in which a complicated process and time are required.

At Step S800, the firmware update process is completed.

Thereafter, when the system is rebooted, the updated firmware is applied, and the above-mentioned booting process is performed.

It is an object of the present disclosure to provide a hybrid memory including a DRAM and a flash memory and having a one-bit synchronization function and a booting method and a booting system capable of speeding up the booting process by copying firmware from the flash memory to the DRAM in a one-bit synchronization basis without an intervention of a CPU by using the hybrid memory.

According to the present disclosure, a time required to copy the firmware from the flash memory to the DRAM can be reduced to a time for copying one-bit information, and hence the booting process of the system can be speeded up.

Further, according to some embodiments, when updating the firmware, the firmware can be updated in a short time in a simple manner, compared to the conventional method of updating the firmware in the flash memory.

Note 1

A method of updating firmware, the method comprising:

storing firmware update information in a DRAM of a hybrid memory that includes a flash memory and the DRAM; and

copying the firmware update information from the DRAM to the flash memory in a one-bit synchronization basis in which bit information is copied in a plurality of hybrid cells included in the hybrid memory in a simultaneous manner.

Note 2

The method according to Note 1, wherein the copying includes copying the firmware update information from the DRAM to the flash memory in a time for copying one-bit information.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

1-5. (canceled)

6. A booting system of a computer system, the booting system comprising:
a hybrid memory including a plurality of hybrid cells each including a DRAM (Dynamic Random Access Memory) area and a flash memory area and each having a one-bit synchronization function of copying bit information between the DRAM area and the flash memory area, the flash memory area storing therein firmware for booting the computer system;
a power detection unit configured to detect a power activation;
a hybrid memory control unit configured, upon the power detection unit detecting the power activation, to copy the firmware stored in the flash memory area to the DRAM area in a one-bit synchronization basis in which a single piece of bit information is copied in each of all the plurality of hybrid cells in a simultaneous manner; and
a system control unit including a CPU (Central Processing Unit) configured
to access the DRAM area,
to read the firmware from the DRAM area, and
to perform a booting process based on the firmware read from the DRAM area,
wherein
upon the power detection unit detecting the power activation, the hybrid memory control unit is configured to copy the firmware stored in the flash memory area to the DRAM area in the one-bit synchronization basis without an intervention of the CPU, and
after the booting process is completed, the CPU is configured to control all operations of the computer system.

7. The booting system according to claim 6, wherein the hybrid memory control unit is configured to copy the firmware from the flash memory area to the DRAM area in a time for copying one-bit information.

8. The booting system according to claim 6, wherein the hybrid memory includes
a cell memory unit including the plurality of hybrid cells, and
a cell controller configured to control the bit information stored in each of the plurality of hybrid cells.

9. The booting system according to claim 6, wherein each of the plurality of hybrid cells includes
a DRAM circuit included in the DRAM area and configured to store one-bit information,
a flash memory circuit included in the flash memory area and configured to store one-bit information, and
a bit transfer unit configured
to electrically connect the DRAM area and the flash memory area, and
to allow the bit information to be transferred between the DRAM area and the flash memory area in a bidirectional manner.

10. The booting system according to claim 6, wherein when updating the firmware, the hybrid memory control unit is configured
to store firmware update information in the DRAM area, and
to copy the firmware update information from the DRAM area to the flash memory area in the one-bit synchronization basis.

11. The booting system according to claim 10, wherein the hybrid memory control unit is configured to copy the firmware update information from the DRAM area to the flash memory area in a time for copying one-bit information.

12. A booting method in a booting system of a computer system, the booting system including a hybrid memory including a plurality of hybrid cells each including a DRAM (Dynamic Random Access Memory) area and a flash memory area and each having a one-bit synchronization function of copying bit information between the DRAM area and the flash memory area, the flash memory area storing therein firmware for booting the computer system, a power detection unit, a hybrid memory control unit, and a system control unit including a CPU (Central Processing Unit), the booting method comprising:
detecting, by the power detection unit, a power activation;
copying, by the hybrid memory control unit, upon detecting the power activation, the firmware stored in the flash memory area to the DRAM (Dynamic Random Access Memory) area in a one-bit synchronization basis in which a single piece of bit information is copied in each of all the plurality of hybrid cells in a simultaneous manner; and
booting, by the CPU, upon completing a copy of the firmware from the flash memory area to the DRAM area, including accessing the DRAM area, reading the firmware from the DRAM area, and performing a booting process based on the firmware read from the DRAM area, wherein
the copying includes, upon the power detection unit detecting the power activation, copying the firmware stored in the flash memory area to the DRAM area in the one-bit synchronization basis without an intervention of the CPU, and
after the booting process is completed, the CPU is configured to control all operations of the computer system.

13. The booting method according to claim 12, wherein the copying includes copying the firmware from the flash memory area to the DRAM area in a time for copying one-bit information.

14. The booting method according to claim 12, further comprising, when updating the firmware,
storing, by the hybrid memory control unit, firmware update information in the DRAM area; and
copying, by the hybrid memory control unit, the firmware update information from the DRAM area to the flash memory area in the one-bit synchronization basis.

15. The booting method according to claim 14, wherein the copying includes copying the firmware update information from the DRAM area to the flash memory area in a time for copying one-bit information.
